(19) United States
(12) Patent Application Publication
(10) Pub. No.: US 2025/0117472 A1
(43) Pub. Date: Apr. 10, 2025

(54) METHODS AND SYSTEMS FOR SYNCHRONIZING TRUSTED OPERATING SYSTEMS

(71) Applicant: ATI Technologies ULC, Markham (CA)

(72) Inventors: Hao Chen, Vancouver (CA); Manuchehr Taghi-Loo, Markham (CA); Dmytro Chenchykov, Markham (CA)

(73) Assignee: ATI Technologies ULC, Markham (CA)

(21) Appl. No.: 18/896,418

(22) Filed: Sep. 25, 2024

Related U.S. Application Data
(60) Provisional application No. 63/589,014, filed on Oct. 9, 2023.

(51) Int. Cl. G06F 21/53; G06F 9/50; G06F 21/54

(52) U.S. Cl. CPC G06F 21/53; G06F 9/5016; G06F 21/54

(57) ABSTRACT

A method for synchronizing trusted operating systems can include receiving, at a first interconnect circuit, an operating system management instruction for a first trusted operating system that is associated with a first trusted memory region of a memory device, the first trusted memory region being allocated to the first interconnect circuit. The method can also include synchronizing the operating system management instruction with a second interconnect circuit such that the operating system management instruction is applied to a second trusted operating system. The second trusted operating system is associated with a second trusted memory region of the memory device and the second trusted memory region is allocated to the second interconnect circuit. Various other methods and systems are also disclosed.

### CROSS REFERENCE TO RELATED APPLICATION

This application claims the benefit of U.S. Provisional Application No. 63/589,014, filed Oct. 9, 2023, the disclosure of which is incorporated, in its entirety, by this reference.

### BACKGROUND

Security is a ubiquitous challenge, particularly as more and more of the daily tasks of businesses, governments, and individuals depend on the use of data and application services. At the same time, the number of successful cyberattacks is increasing, as does the attackers' motivation to find and exploit the vulnerabilities. Defense against these attacks is only as strong as the weakest link. Thus, the secure design and operation of applications and systems is critical.

Security at the CPU and system-on-chip (SoC) level is starting to play an unexpectedly large role at the system level. This is because of changes in system and application structure (particularly the rise and ubiquity of virtualization over the past decade), because of the importance of defining trust and limiting attack surfaces, and because of the foundational role that only secure hardware can play. Chip-level security is likely to become even more important as the Internet of Things distributes processing power toward edge infrastructure.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for synchronizing trusted operating systems, according to one or more implementations of the present disclosure.

FIG. 2 is a block diagram of an example system for synchronizing trusted operating systems, according to one or more implementations of the present disclosure.

FIG. 3 is a block diagram of an additional example system for synchronizing trusted operating systems, according to one or more additional implementations of the present disclosure.

FIG. 4 is a flow diagram of an example method for synchronizing trusted operating systems, according to one or more implementations of the present disclosure.

FIG. 5 is a block diagram of an example system for synchronizing trusted operating systems, according to one or more implementations of the present disclosure.

FIG. 6 is a block diagram illustrating synchronization of trusted operating systems, according to one or more implementations of the present disclosure.

FIG. 7 is a block diagram of an example device package having an interposer die.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to synchronizing trusted operating systems. Example implementations set forth herein can synchronize operating systems of multiple systems on chip (SoCs.) For example, the disclosed systems and methods can synchronize trusted operating systems of multiple security processors (e.g., root of trust (ROT) microprocessors) coupled to multiple interconnect devices (e.g., active interposer dies (AIDs)) within a socket of a printed circuit board (PCB).

Systems on chip (SoCs) can refer to a type of integrated circuit (IC) design that combines many or all high-level function elements of an electronic device onto a single chip instead of using separate components mounted to a printed circuit board (PCB), such as a motherboard. In an SoC, a central processing unit (CPU) can be fully integrated with memory, graphics processing units (GPUs), and more on a single chip.

A printed circuit board (PCB) can be a medium used in electrical and electronic engineering to connect electronic components to one another in a controlled manner. For example a PCB can take the form of a laminated sandwich structure of conductive and insulating layers, with each of the conductive layers being designed with an artwork pattern of traces, planes, and other features (e.g., like wires on a flat surface) etched from one or more sheet layers of copper laminated onto and/or between sheet layers of a non-conductive substrate. Electrical components can be fixed to conductive pads on the outer layers in the shape designed to accept the component's terminals, generally by means of soldering, to both electrically connect and mechanically fasten them to it. Another manufacturing process can add vias, such as plated-through holes that allow interconnections between layers. PCBs can be single-sided (e.g., one copper layer), double-sided (e.g., two copper layers on both sides of one substrate layer), or multi-layer (e.g., outer and inner layers of copper, alternating with layers of substrate). Multi-layer PCBs allow for much higher component density because circuit traces on the inner layers would otherwise take up surface space between components. SoCs and/or circuit dies can be mounted in one or more sockets of a PCB, and some sockets can accommodate mounting of multiple SoCs and/or circuit dies.

A socket can be an electrical component of a land grid array (LGA) package or pin grid array (PGA) package that provides compressive electrical interconnect between a PCB and a processor. For example, an LGA socket can offer a more durable CPU as the contact pins are on the motherboard socket. In contrast, a PGA socket can offer a more durable motherboard as the pins are on the processor. However, LGA pins are smaller than PGA pins and hence, the LGA socket can offer more space efficiency.

Implementation of multiple SoCs within a socket can benefit from synchronization of their respective trusted operating systems. The trusted operating systems can be loaded from secure memory regions and/or reset by security processors of each SoC. A security processor can also be referred to as a root of trust.

A root of trust can correspond to a logic block that resides in a silicon die that maintains the trust. For example, and without limitation, a root of trust can maintain a trust using one or more encryption schemes, digital signatures, and/or secret keys. In use, a root of trust (ROT) can be implemented as a source that can always be trusted within a cryptographic system. Because cryptographic security is dependent on keys to encrypt and decrypt data and perform functions such as generating digital signatures and verifying signatures, ROT schemes generally include a hardened hardware module. In this context, a hardware root of trust can be the foundation on which all secure operations of a computing system depend. It can contain the keys used for cryptographic functions and enable a secure boot process. It is inherently trusted, and therefore must be secure by design. The most secure implementation of a root of trust is in hardware making it immune from malware attacks. As such, it can be a stand-alone security module or implemented as a security module within a processor or system on chip (SoC).

In a multi-chip system, reset includes loading a trusted operating system (TOS) on all active interposer dies (AIDs). A driver can be responsible for loading of the TOS. However, the driver only communicates with a platform security processor (PSP) boot loader on a first AID (e.g., AID0) of every socket. The disclosed systems and methods can synchronize the TOSs of multiple security processors by causing AID0 to broadcast a TOS load command received from the driver to additional AIDs (e.g., AID1, AID2, AID3).

The disclosed systems and methods can achieve numerous benefits. For example, the disclosed systems and methods can achieve improved security of SoCs. Additionally, since the trusted operating system (TOS) load command can be broadcast, rather than sent to only a single active interposer die (AID), the AIDs can load the TOS in parallel. Also, resets can more efficiently be completed. Moreover, the disclosed systems and methods can achieve improved coordination of the parallel loading.

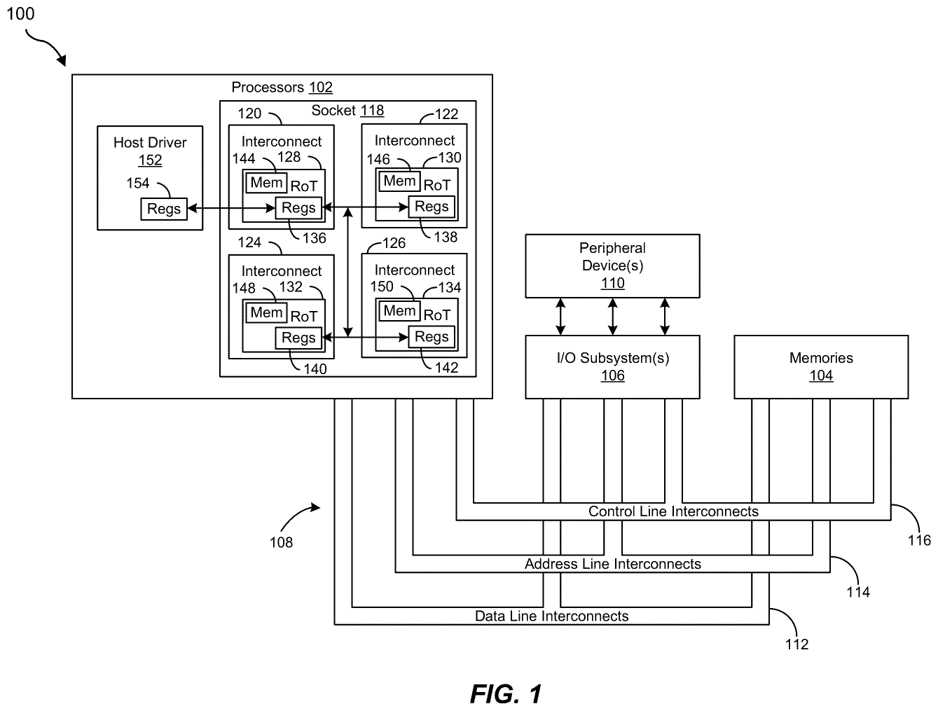

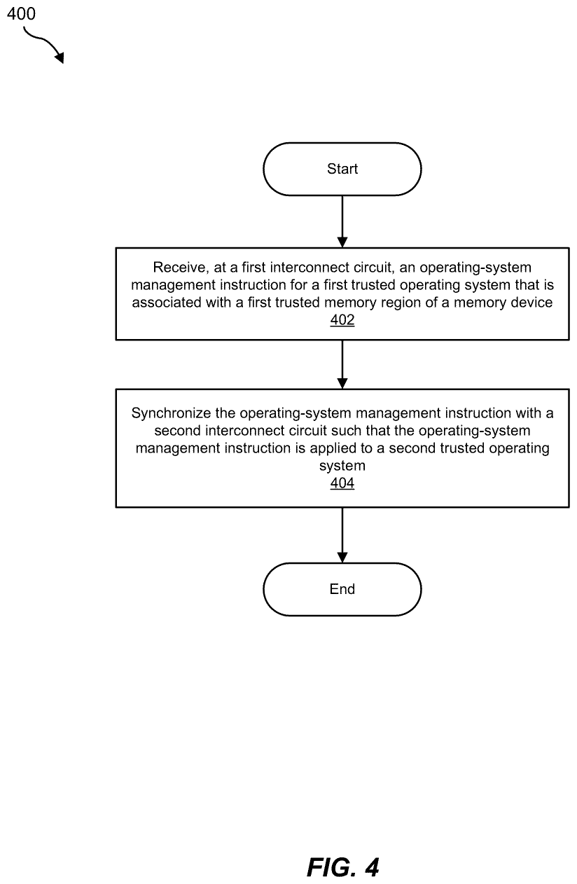

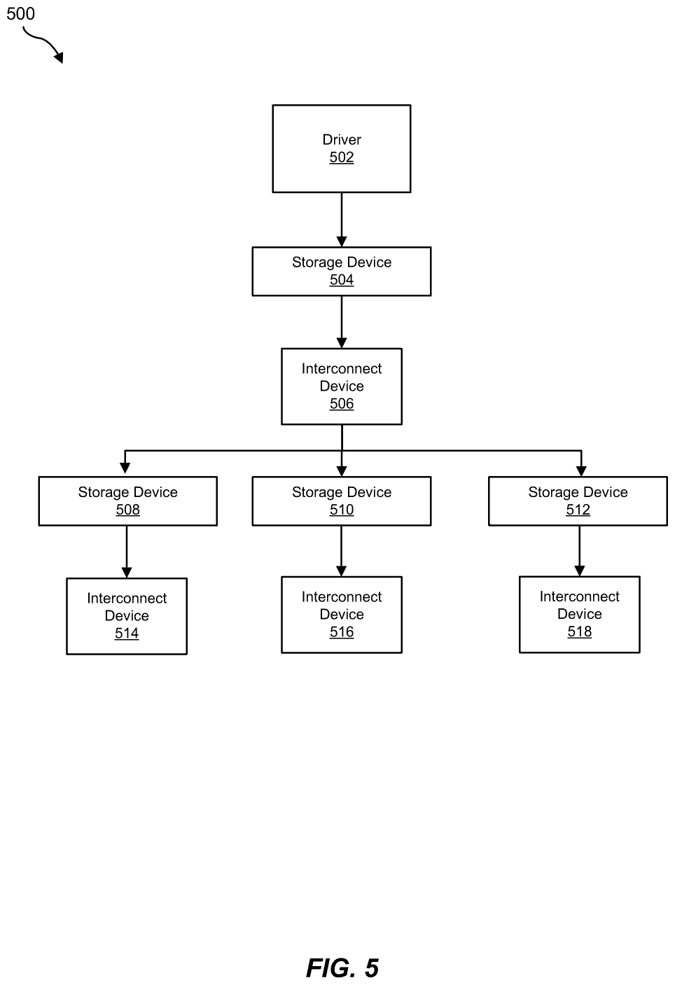

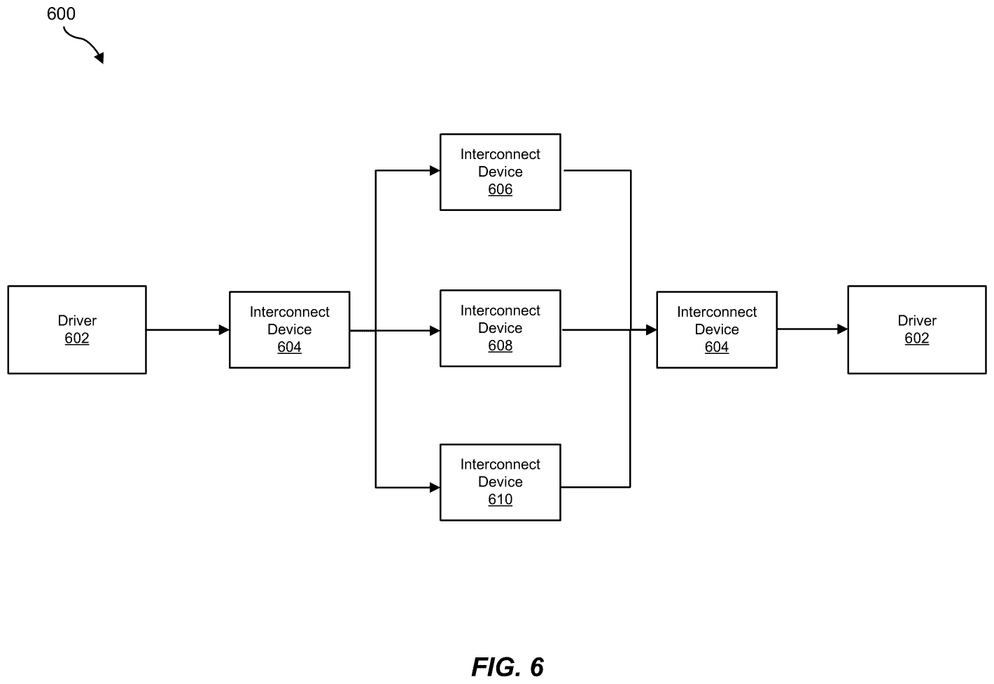

The following will provide, with reference to FIGS. 1, 2, 3, and 7, detailed descriptions of example systems for synchronizing trusted operating systems. Detailed descriptions of corresponding computer-implemented methods will also be provided in connection with FIG. 4. In addition, detailed descriptions of example systems for synchronizing trusted operating systems will be provided in connection with FIGS. 5 and 6.

In one example, a device can include a first interconnect circuit and a security microprocessor coupled to the first interconnect circuit and configured to receive an operating system management instruction for a first trusted operating system that is associated with a first trusted memory region of a memory device, the first trusted memory region being allocated to the first interconnect circuit and synchronize the operating system management instruction with a second interconnect circuit such that the operating system management instruction is applied to a second trusted operating system, wherein the second trusted operating system is associated with a second trusted memory region of the memory device and the second trusted memory region is allocated to the second interconnect circuit.

Another example can be the previously described example device, wherein the first interconnect circuit includes a first interposer die and the second interconnect circuit includes a second interposer die.

Another example can be any of the previously described example devices, wherein the first interposer die includes a first active interposer die and the second interposer die includes a second active interposer die.

Another example can be any of the previously described example devices, wherein the first interconnect circuit is configured to receive the operating system management instruction from a host driver.

Another example can be any of the previously described example devices, wherein the first interconnect circuit is configured to send, to the host driver, a notification indicating that the operating system management instruction has been executed for both the first and second trusted operating systems.

Another example can be any of the previously described example devices, wherein the operating system management instruction includes an instruction to load the first trusted operating system and the first interconnect circuit is configured to request that the second interconnect circuit load the second trusted operating system.

Another example can be any of the previously described example devices, wherein the operating system management instruction includes an instruction to reset the first trusted operating system and the first interconnect circuit is configured to request that the second interconnect circuit reset the second trusted operating system.

In one example, a system can include a first interconnect circuit configured to receive an operating system management instruction for a first trusted operating system that is associated with a first trusted memory region of a memory device, the first trusted memory region being allocated to the first interconnect circuit and a second interconnect circuit configured to receive the operating system management instruction from the first interconnect circuit and apply the operating system management instruction to a second trusted operating system, wherein the second trusted operating system is associated with a second trusted memory region of the memory device and the second trusted memory region is allocated to the second interconnect circuit.

Another example can be the previously described example system, wherein the first interconnect circuit includes a first interposer die and the second interconnect circuit includes a second interposer die.

Another example can be any of the previously described example systems, wherein the first interposer die includes a first active interposer die and the second interposer die includes a second active interposer die.

Another example can be any of the previously described example systems, wherein the first interconnect circuit is configured to receive the operating system management instruction from a host driver.

Another example can be any of the previously described example systems, wherein the first interconnect circuit is configured to send, to the host driver, a notification indicating that the operating system management instruction has been executed for both the first and the second trusted operating systems.

Another example can be any of the previously described example systems, wherein the operating system management instruction includes an instruction to load the first trusted operating system and the first interconnect circuit is configured to request that the second interconnect circuit load the second trusted operating system.

Another example can be any of the previously described example systems, wherein the operating system management instruction includes an instruction to reset the first trusted operating system and the first interconnect circuit is configured to request that the second interconnect circuit reset the second trusted operating system.

In one example, a method can include receiving, at a first interconnect circuit, an operating system management instruction for a first trusted operating system that is associated with a first trusted memory region of a memory device, the first trusted memory region being allocated to the first interconnect circuit and synchronizing the operating system management instruction with a second interconnect circuit such that the operating system management instruction is applied to a second trusted operating system, wherein the second trusted operating system is associated with a second trusted memory region of the memory device and the second trusted memory region is allocated to the second interconnect circuit.

Another example can be the previously described example method, wherein the first interconnect circuit includes a first interposer die and the second interconnect circuit includes a second interposer die.

Another example can be any of the previously described example methods, wherein the first interposer die includes a first active interposer die and the second interposer die includes a second active interposer die.

Another example can be any of the previously described example methods, wherein the operating system management instruction is received from a host driver.

Another example can be any of the previously described example methods, further including sending, to the host driver, a notification indicating that the operating system management instruction has been executed for both the first and the second trusted operating systems.

Another example can be any of the previously described example methods, wherein the operating system management instruction includes an instruction to load the first trusted operating system and synchronizing the operating system management instruction includes requesting that the second trusted operating system be loaded.

FIG. 1 illustrates an example system 100 for synchronizing trusted operating systems. For example, system 100 can include one or more processors 102, one or more memories 104, and one or more input/output (I/O) subsystems 106 connected by a system bus 108. Processors 102 can include central processing units (CPUs) and/or co-processors, such as graphics processing units (GPUs), accelerator processing units (APUs), arithmetic logic units (ALUs), etc. Memories 104 can correspond to electronic holding places for the instructions and/or data that a computer needs to reach quickly, such as cache memory, main memory, and/or secondary memory. I/O subsystems 106 can correspond to devices that transfer data to and/or from a computer and control communication between processors 102 and peripheral devices 110. Peripheral devices 110 can correspond to devices that connect to a core computing unit, such as monitors, mice, keyboards, printers, external memory, etc. In turn, I/O subsystems 106 can include controllers for each of the peripheral devices 110. One or more processors 102, one or more memories 104, and one or more input/output (I/O) subsystems 106 can be implemented as one or more semiconductor device packages connected to one or more printed circuit boards. Some or all of processors 102, memories 104, I/O subsystems 106, system bus 108, and/or peripheral devices 110 can be implemented on a printed circuit board, such as a motherboard.

As shown in FIG. 1, a system bus 108 can be a communication system that transfers data between components inside a computer, or between computers. System bus 108 can include various interconnects, such as data line interconnects 112, address line interconnects 114, and control line interconnects 116. Data line interconnects 112, in the context of technology and computing, can refer to a communication path that facilitates the transmission of data between devices or systems. Address line interconnects 114 can refer to a physical connection between a CPU/chipset and memory and specify which address to access in the memory. Control line interconnects 116 can receive signals that manage varied chip operations (e.g., scan and write). One or more processors 102 can perform interposer seating indication as described herein.

As shown in FIG. 1, processors 102 can include a socket 118 receiving a semiconductor device package, such as a processor package, seated therein. The semiconductor device package can include interconnect devices 120, 122, 124, and 126 (e.g., AIDs). Each interconnect devices 120-126 can have multiple microprocessors, including a security processor 128, 130, 132, and 134 (e.g., ROT). Each security processor 128-134 can include local registers 136, 138, 140, and 142 and have secure memory regions 144, 146, 148, and 150 allocated to individual ones of the security processors 128-134.

Registers 136-142 can correspond to small amounts of storage available as part of a processor. For example, and without limitation, a register can correspond to a quickly accessible location available to a computer's processor and that has been designated as a location for storing data or instructions. In this context, processors can include general purpose registers, instruction registers, memory address registers, memory data registers, etc. In some implementations, registers 136-142 can correspond to graphics mailbox registers that act as pipes between a CPU and a GPU and can be implemented, for example, as general-purpose 32-bit registers that contain messages.

Secure memory regions 144-150 can be implemented in various ways. For example, secure memory regions 144-150 can correspond to local memories of the security processors 128-134. Alternatively or additionally, secure memory regions 144-150 can correspond to allocated regions of one or more memory devices included in the semiconductor device package inserted in socket 118. In some implementations, the one or more memory devices can correspond to high bandwidth memory of the semiconductor device package.

As shown in FIG. 1, processors 102 can include a host driver 152 having local registers 154. Host driver 152 can be implemented by a host processor that can be coupled to a PCB that includes socket 118. The host processor can run a host operating system and the host driver 152 can affect communication between the host operating system and various devices, such as socket 118. Like registers 136-142, registers 154 of host driver 152 can correspond to small amounts of storage available as part of a processor. In some implementations, registers 154 can also correspond to graphics mailbox registers that act as pipes between the host processor and a GPU corresponding the semiconductor device package inserted in socket 118.

As shown in FIG. 1, host driver 152 can be configured to communicate with a boot loader on security processor 128 of interconnect device 120, but not with security processors 130-134 of interconnect devices 122-126. Host driver 152 can transmit an operating system management instruction (e.g., to load or reset a TOS) for a first TOS to registers 136 of security processor 128. The first TOS can be associated with (e.g., stored in) a first trusted memory region 144 of a memory device. Upon receipt of the instruction, security processor 128 can broadcast the instruction to registers 138-142 of security processors 130-134 of interconnect devices 122-126. In response to the broadcast instruction, security processors 130-134 can reset their respective TOS and/or load their respective TOSs in parallel from their respective trusted memory regions 146-150. Security processors 130-134 can also transmit messages to security processor 128 that the resetting and/or loading of their respective TOSs are complete. Security processor can further reset and/or load its respective TOS from its own trusted memory region 144. In some implementations, this reset and/or load by security processor 128 can occur in parallel with those of security processors 130-134. Alternatively or additionally, this reset and/or load by security processor 128 can occur after receiving the notifications from security processors 130-134. Once security processor has completed resetting or loading its own TOS and received messages from security processors 130-134, it can transmit a message to host driver 152 that the reset and/or load is complete. In this way, security processor 128 can perform in a role as a host driver for security processors 130-134 while achieving synchronization of the TOSs through parallel reset and/or loading.

Communication between mailbox registers 136-142 and 154 can occur over various communication media. For example, and without limitation, messages can be exchanged by transceivers over wire bonds. Alternatively or additionally, messages can be exchanged between registers using traces, links, lines, or any other electrical or optical connection. In some implementations, at least part of the communication medium can include a local bus embedded in socket 118 and/or a PCB that includes socket 118. In some implementations, at least part of the communication can be carried out by an interposer. Communication channels between the registers can include a data path and a control path.

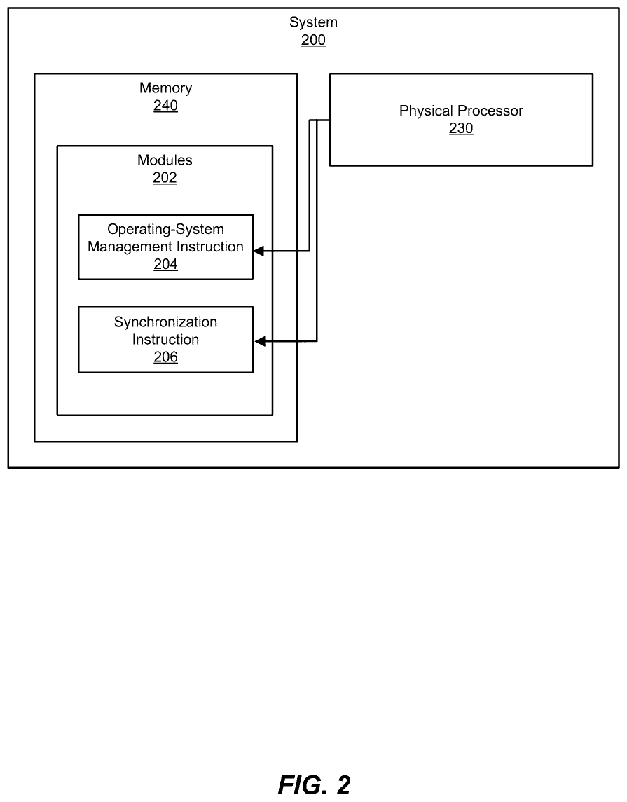

FIG. 2 is a block diagram of an example system 200 for synchronizing trusted operating systems, such as in a multi-chip system. As illustrated in this figure, example system 200 can include one or more modules 202 for performing one or more tasks. As will be explained in greater detail below, modules 202 can include operating system management instruction 204 and synchronization instruction 206. Although illustrated as separate elements, one or more of modules 202 in FIG. 2 can represent portions of a single module or application.

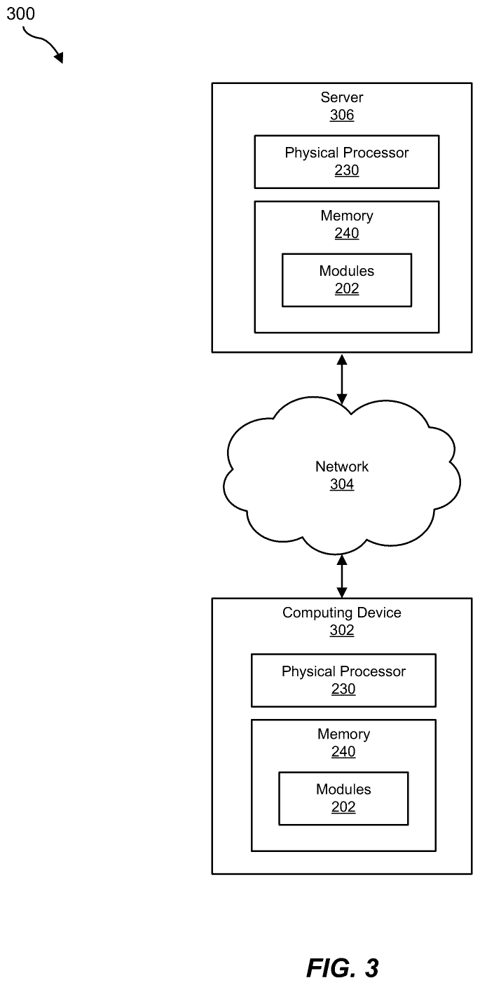

In certain implementations, one or more of modules 202 in FIG. 2 can represent one or more software applications or programs that, when executed by a computing device, can cause the computing device to perform one or more tasks. For example, and as will be described in greater detail below, one or more of modules 202 can represent modules stored and configured to run on one or more computing devices, such as the devices illustrated in FIG. 3 (e.g., computing device 302 and/or server 306). One or more of modules 202 in FIG. 2 can also represent all or portions of one or more special-purpose computers configured to perform one or more tasks and may be implemented with one or more circuits.

As illustrated in FIG. 2, example system 200 can also include one or more memory devices, such as memory 240. Memory 240 generally represents any type or form of volatile or non-volatile storage device or medium capable of storing data and/or computer-readable instructions. In one example, memory 240 can store, load, and/or maintain one or more of modules 202. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 2, example system 200 can also include one or more physical processors, such as physical processor 230. Physical processor 230 generally represents any type or form of hardware-implemented processing unit capable of interpreting and/or executing computer-readable instructions. In one example, physical processor 230 can access and/or modify one or more of modules 202 stored in memory 240. Additionally or alternatively, physical processor 230 can execute one or more of modules 202 to facilitate loading of operating systems (e.g., trusted operating systems) associated with trusted memory regions of a memory device and synchronizing such loading (e.g., across multiple interconnect devices of a multi-chip system). Examples of physical processor 230 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Example system 200 in FIG. 2 can be implemented in a variety of ways. For example, all or a portion of example system 200 can represent portions of example system 300 in FIG. 3. As shown in FIG. 3, system 300 can include a computing device 302 in communication with a server 306 via a network 304. In one example, all or a portion of the functionality of modules 202 can be performed by computing device 302, server 306, and/or any other suitable computing system. As will be described in greater detail below, one or more of modules 202 from FIG. 2 can, when executed by at least one processor of computing device 302 and/or server 306, enable computing device 302 and/or server 306 to synchronize trusted operating systems (e.g., across multiple interconnect devices of a multi-chip system).

Computing device 302 generally represents any type or form of computing device capable of reading computer-executable instructions. Additional examples of computing device 302 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 306 generally represents any type or form of computing device that is capable of synchronizing trusted operating systems. Additional examples of server 306 include, without limitation, storage servers, database servers, application servers, and/or web servers configured to run certain software applications and/or provide various storage, database, and/or web services. Although illustrated as a single entity in FIG. 3, server 306 can include and/or represent a plurality of servers that work and/or operate in conjunction with one another.

Network 304 generally represents any medium or architecture capable of facilitating communication or data transfer. In one example, network 304 can facilitate communication between computing device 302 and server 306. In this example, network 304 can facilitate communication or data transfer using wireless and/or wired connections. Examples of network 304 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 200 in FIG. 2 and/or system 300 in FIG. 3. Conversely, all of the components and devices illustrated in FIGS. 2 and 3 need not be present to practice the implementations described and/or illustrated herein. The devices and subsystems referenced above can also be interconnected in different ways from that shown in FIG. 3. Systems 200 and 300 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

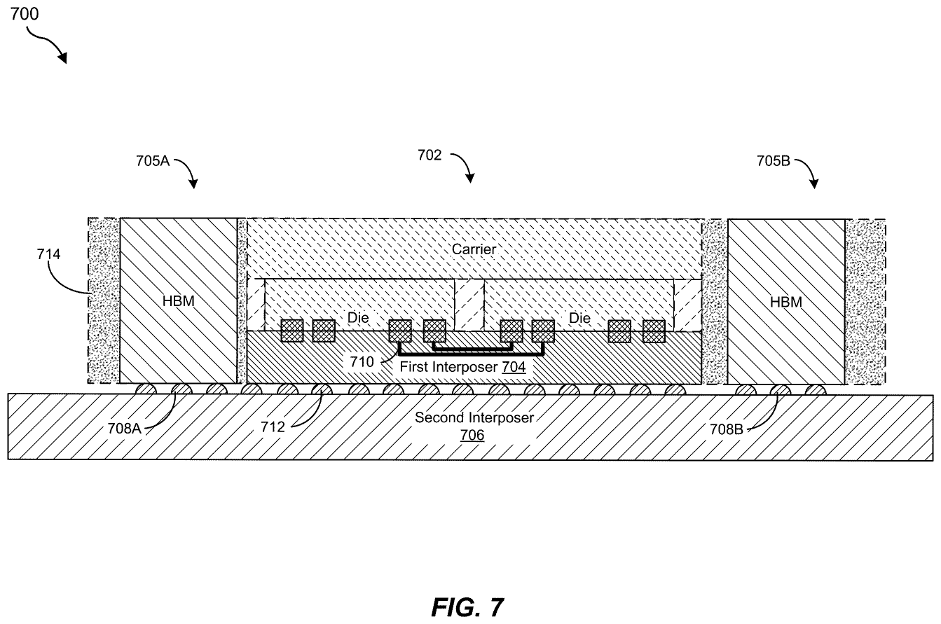

FIG. 4 is a flow diagram of an example computer-implemented method 400 for synchronizing trusted operating systems. The steps shown in FIG. 4 can be performed by any suitable computer-executable code and/or computing system, including system 100 in FIG. 1, system 200 in FIG. 2, system 300 in FIG. 3, package 700 in FIG. 7, and/or variations or combinations of one or more of the same. In one example, each of the steps shown in FIG. 4 can represent an algorithm whose structure includes and/or is represented by multiple sub-steps, examples of which will be provided in greater detail below.

As illustrated in FIG. 4, at step 402 one or more of the systems described herein can receive, at a first interconnect circuit, an operating system management instruction for a first trusted operating system that is associated with a first trusted memory region of a memory device. The first trusted memory region can be allocated to the first interconnect circuit.

At step 404, one or more of the systems described herein can synchronize the operating system management instruction with a second interconnect circuit such that the operating system management instruction is applied to a second trusted operating system. The second trusted operating system can be associated with a second trusted memory region of the memory device. The second trusted memory region can be allocated to the second interconnect circuit.

FIG. 5 illustrates a diagram 500 of how a driver 502 (e.g., a host driver) communicates with an interconnect device 506 (e.g., AID0 which in some examples corresponds to first interposer 704) via a storage device 504, which uses additional storage devices 508, 510, 512 (e.g., graphics mailbox registers) to synchronize the communication to other respective interconnect devices 514, 516, 518 (e.g., AID1, AID2, AID3). Driver 502 uses storage devices 508, 510, 512 to handshake between interconnect devices 514, 516, 518 and interconnect device 506 for any communication purpose. Since driver 502 does not communicate directly with the other interconnect devices 514, 516, 518, interconnect device 506 utilizes the storage devices 508, 510, 512 on the other interconnect devices 514, 516, 518 to communicate the command(s), such as loading a TOS on the other interconnect devices 514, 516, 518 in case of a reset.

FIG. 6 illustrates a diagram 600 for demonstrating the how an interconnect device 604 (e.g., AID0 which in some examples can correspond to first interposer 704) of a multi-chip system broadcasts commands from a driver 602 (e.g., a host driver) to other interconnect devices 606, 608, 610 (e.g, AID1, AID2, AID3, etc.) of the multi-chip system. The flow of TOS load (e.g., in case of a reset) can be broken down into the following steps:

1. Driver 602 communicates a TOS load command to interconnect device 604 through its storage device (e.g., via graphics mailbox registers in its storage device).

2. Interconnect device 604 checks to ensure the command is to load the TOS.

3. Interconnect device 604 broadcasts the TOS load command (e.g., requesting that the TOS be loaded and/or reset) to the other interconnect devices 606, 608, 610 via respective storage devices (e.g., individual graphics mailbox registers) of the other interconnect devices 606, 608, 610.

4. Once the other interconnect devices 606, 608, 610 receive the command, the TOS is loaded onto the other interconnect devices 606, 608, 610.

5. After the TOS is loaded on the other interconnect devices 606, 608, 610, they communicate back to interconnect device 604 to confirm that loading is complete.

6. Interconnect device 604 itself also loads the TOS.

7. Interconnect device 604 sends a notification to the driver 602 that all interconnect devices 604, 606, 608, 610 have completed loading of the TOS, and driver 602 can proceed.

FIG. 7 illustrates an example package 700, corresponding to system 200 and/or system 300 (and/or portions thereof), for implementing any of the systems and methods described herein. Package 700 has a two-stack interposer and can include a plurality of stacked circuit dies (e.g., 3D chiplet stacks) connected to a first interposer 704 (e.g., an active interposer die such as described herein). The term “circuit die,” as used herein, can generally refer to a small block of semiconducting material on which a given functional circuit is fabricated (e.g., a memory unit, logic unit, etc.). For example, and without limitation, integrated circuits can be produced in large batches on a single wafer of electronic-grade silicon (EGS) or other semiconductor through processes such as photolithography. The term “stacked,” as used herein, can generally refer to 3D packaging. For example, and without limitation, stacked circuit dies can be configured according to 3D integration schemes that rely on traditional interconnection methods such as wire bonding and flip chip to achieve vertical stacking. Example types of 3D packages can include 3D system in package (3D SiP) and 3D wafer level package (3D WLP). Although FIG. 7 illustrates a single die tier for stacked circuit dies 702, other implementations may include additional die tiers. The term “interposer,” as used herein, can generally refer to an electrical interface routing between one socket or connection to another. For example, and without limitation, an interposer can spread a connection to a wider pitch or reroute a connection to a different connection. Types of interposers can include silicon interposers, silicon interposers that use system on integrated chip_horizontal (SoIC_H) technology, organic interposers, and glass interposers. Unlike organic interposers and glass interposers, silicon interposers are composed of SiO2 or polymers and have a relatively higher cost (e.g., three times higher per wafer).

In some implementations, package 700 can additionally include a second interposer 706 connected to the first interposer 704. In some examples, package 700 can also include an additional plurality of stacked circuit dies 705A and 705B connected to the second interposer 706, although in other implementations other connections can be used. Moreover, each of stacked circuit dies 705A and/or 705B may include one or more die tiers.

Parts of package 700 can be connected in various ways. For example, the additional plurality of stacked circuit dies 705A and 705B can be connected to the second interposer 706 by one or more solder interconnects 708A and 708B. Additionally in some examples, first interposer 704 can be connected to the plurality of stacked circuit dies 702 by hybrid bonding. The term “hybrid bonding,” as used herein, can generally refer to forming a permanent bond that combines a dielectric bond with embedded metal (e.g., copper) to form interconnections. For example, and without limitation, hybrid bonding can allow for face-to-face connection of wafers or dies and provide both mechanical support and dense electrical interconnects. In some examples, hybrid bonding can be used for advanced 3D device stacking and heterogeneous integration applications. Hybrid bonding can deliver up to one-thousand times more connections than copper microbumps and reduce signal delay. Also, second interposer 706 can be connected to first interposer 704 by one or more solder interconnects 712. The term “solder interconnects,” as used herein, can generally refer to electrical connections made using a fusible metal alloy to create a permanent bond between metal workpieces. For example, and without limitation, solder interconnects can be made with solder bumps that are small spheres of solder (e.g., solder balls) that are bonded to contact areas or pads of semiconductor devices. Solder bumps can be used for face-down bonding.

Parts of package 700 can vary in numerous ways. For example, the additional plurality of stacked circuit dies 705A and 705B can correspond to at least one high bandwidth memory (HBM) stack. The term “high bandwidth memory,” as used herein, can generally refer to a high-speed computer memory interface for 3D-stacked synchronous dynamic random-access memory (SDRAM). For example, and without limitation, high bandwidth memory can be used in conjunction with high-performance graphics accelerators, network devices, high-performance datacenter AI ASICs and FPGAs, and in some supercomputers. Additionally, first interposer 704 can correspond to a silicon interposer (e.g., an SoIC_H interposer). Also, second interposer 706 can be made of organic material and/or glass and in some examples may correspond to a substrate such as a printed circuit board (PCB).

In some implementations, data communication between different stacks of circuit dies of plurality of stacked circuit dies 702 can be handled by first interposer 704, such as through one or more interconnect 710 (corresponding to conductive elements such as wiring, through-silicon vias (TSV), etc.) in first interposer 704. In some examples, data communication between different stacked circuit dies 702 can be handled exclusively by first interposer 704. In some examples, data communication between circuit dies of a same stack of circuit dies 702 can be handled though interconnects therebetween (e.g., TSVs, and other conductive elements, not shown in FIG. 7). In addition, data communication between the plurality of stacked circuit dies 702 and the additional plurality of stacked circuit dies 705A and 705B can be handled by first interposer 704 and second interposer 706 in combination and/or individually.

Package 700 can have additional parts. For example, package 700 can include mold material 714 (e.g., non-dielectric epoxy) provided between and/or beside the plurality of stacked circuit dies 702 and additional stacked circuit dies 704A and/or 704B. Additionally, massively parallel chips (e.g., stacked circuit dies 702) can include tiered circuit dies and/or wafers arranged beneath a top carrier with gap filler (e.g., dielectric epoxy) provided between and/or beside the tiered circuit dies.

By way of example, one or more interposer dies (e.g., one or more of first interposer 704 and/or second interposer 706) can receive an OS management instruction for a first trusted OS associated with one or more first trusted memory regions of a memory device (e.g., one or more of HBM of stacked dies 705A and/or 705B and/or 702) and further, one or more of the interposer dies can synchronize the OS management instruction to apply to a second trusted OS (e.g., as in steps 402 and 404). More specifically, a driver (e.g., driver 152, driver 502, and/or driver 602) can be implemented with a memory (e.g., memory 240 and in some implementations one or more dies of stacked dies 702, 705A, and/or 705B). The driver can coordinate, for instance, a handshake between interposer dies (e.g., first interposer 704 and/or second interposer 706 and/or multiple iterations thereof such that interconnect devices 120, 122, 124, 126, 506, 514, 516, 518, 604, 606, 608, and/or 610 can correspond to one or more iterations of first interposer 704 and/or second interposer 706) via a storage device (e.g., respective dies of stacked dies 705A, 705B, and/or 702 such that storage devices 504, 508, 510, and/or 512 can correspond to one or more iterations and/or portions of stacked dies 702, 705A, and/or 705B) as described herein. The driver can further broadcast commands to the interposer dies (e.g., one or more iterations of first interposer 704 and/or second interposer 706) as described herein.

As set forth above, in a multi-chip system, reset can include loading a trusted operating system (TOS) on all active interposer dies (AIDs). A driver can be responsible for loading of the TOS. However, the driver only communicates with a platform security processor (PSP) boot loader on a first AID (e.g., AID0) of every socket. The disclosed systems and methods can synchronize the TOSs of multiple security processors by causing AID0 to broadcast a TOS load command received from the driver to additional AIDs (e.g., AID1, AID2, AID3).

The disclosed systems and methods can achieve numerous benefits. For example, the disclosed systems and methods can achieve improved security of SoCs. Additionally, since the trusted operating system (TOS) load command can be broadcast, rather than sent to only a single active interposer die (AID), the AIDs can load the TOS in parallel. Also, resets can more efficiently be completed. Moreover, the disclosed systems and methods can achieve improved coordination of the parallel loading.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 200 in FIG. 2 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 200 in FIG. 2 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 200 in FIG. 2 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 200 in FIG. 2 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a first interconnect circuit; and
a security microprocessor coupled to the first interconnect circuit and configured to:
receive an operating system management instruction for a first trusted operating system that is associated with a first trusted memory region of a memory device, the first trusted memory region being allocated to the first interconnect circuit; and
synchronize the operating system management instruction with a second interconnect circuit such that the operating system management instruction is applied to a second trusted operating system, wherein:
the second trusted operating system is associated with a second trusted memory region of the memory device; and
the second trusted memory region is allocated to the second interconnect circuit.

2. The device of claim 1, wherein:
the first interconnect circuit comprises a first interposer die; and
the second interconnect circuit comprises a second interposer die.

3. The device of claim 2, wherein:
the first interposer die comprises a first active interposer die; and
the second interposer die comprises a second active interposer die.

4. The device of claim 1, wherein the first interconnect circuit is configured to receive the operating system management instruction from a host driver.

5. The device of claim 4, wherein the first interconnect circuit is configured to send, to the host driver, a notification indicating that the operating system management instruction has been executed for both the first trusted operating system and the second trusted operating system.

6. The device of claim 1, wherein:
the operating system management instruction comprises an instruction to load the first trusted operating system; and
the first interconnect circuit is configured to request that the second interconnect circuit load the second trusted operating system.

7. The device of claim 1, wherein:
the operating system management instruction comprises an instruction to reset the first trusted operating system; and
the first interconnect circuit is configured to request that the second interconnect circuit reset the second trusted operating system.

8. A system, comprising:
a first interconnect circuit configured to receive an operating system management instruction for a first trusted operating system that is associated with a first trusted memory region of a memory device, the first trusted memory region being allocated to the first interconnect circuit; and
a second interconnect circuit configured to receive the operating system management instruction from the first interconnect circuit and apply the operating system management instruction to a second trusted operating system, wherein:
the second trusted operating system is associated with a second trusted memory region of the memory device; and
the second trusted memory region is allocated to the second interconnect circuit.

9. The system of claim 8, wherein:
the first interconnect circuit comprises a first interposer die; and
the second interconnect circuit comprises a second interposer die.

10. The system of claim 9, wherein:
the first interposer die comprises a first active interposer die; and
the second interposer die comprises a second active interposer die.

11. The system of claim 8, wherein the first interconnect circuit is configured to receive the operating system management instruction from a host driver.

12. The system of claim 11, wherein the first interconnect circuit is configured to send, to the host driver, a notification indicating that the operating system management instruction has been executed for both the first trusted operating system and the second trusted operating system.

13. The system of claim 8, wherein:
the operating system management instruction comprises an instruction to load the first trusted operating system; and
the first interconnect circuit is configured to request that the second interconnect circuit load the second trusted operating system.

14. The system of claim 8, wherein:
the operating system management instruction comprises an instruction to reset the first trusted operating system; and
the first interconnect circuit is configured to request that the second interconnect circuit reset the second trusted operating system.

15. A method comprising:
receiving, at a first interconnect circuit, an operating system management instruction for a first trusted operating system that is associated with a first trusted memory region of a memory device, the first trusted memory region being allocated to the first interconnect circuit; and
synchronizing the operating system management instruction with a second interconnect circuit such that the operating system management instruction is applied to a second trusted operating system, wherein:
the second trusted operating system is associated with a second trusted memory region of the memory device; and
the second trusted memory region is allocated to the second interconnect circuit.

16. The method of claim 15, wherein:
the first interconnect circuit comprises a first interposer die; and
the second interconnect circuit comprises a second interposer die.

17. The method of claim 16, wherein:
the first interposer die comprises a first active interposer die; and
the second interposer die comprises a second active interposer die.

18. The method of claim 15, wherein the operating system management instruction is received from a host driver.

19. The method of claim 18, further comprising sending, to the host driver, a notification indicating that the operating system management instruction has been executed for both the first trusted operating system and the second trusted operating system.

20. The method of claim 15, wherein:
the operating system management instruction comprises an instruction to load the first trusted operating system; and
synchronizing the operating system management instruction comprises requesting that the second trusted operating system be loaded.
